(19) United States
(12) Patent Application Publication
(10) Pub. No.: US 2007/0022028 A1
(43) Pub. Date: Jan. 25, 2007

(54) System design tool according to reusable asset specifications

(75) Inventors: Wayne J. Wulfert, East Peoria, IL (US); Vern R. Smith, Peoria, IL (US); Walt E. Earleson, Morton, IL (US); Dale B. Herget, Mapleton, IL (US); Wayne D. Brandt, Morton, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/185,942

(22) Filed: Jul. 21, 2005

(51) Int. Cl. G06Q 40/00

(52) U.S. Cl. 705/35

(57) ABSTRACT

An asset catalog is disclosed which includes a plurality of software assets and at least one hardware asset configured to be selectively functionally interconnected with at least one of the plurality of software assets. The plurality of software assets and the at least one hardware asset are organized in accordance with reusable asset specifications.

### TECHNICAL FIELD

The present disclosure relates generally to a system design tool, and more particularly, to a system design tool according to reusable asset specifications.

### BACKGROUND

Computer applications, such as computer readable codes, can be designed within a design environment that typically includes a computer and a graphically interfaced system design tool. System design tools typically include a software program that allows a user to design an application using an interrelated function-based approach within the graphical interface. Such system design tools usually interconnect a plurality of sub-routines and generate a software code configured to control, operate, and/or interact with a hardware component. Typically, a user has special knowledge regarding the hardware component, such as, for example, required inputs, type of inputs, physical characteristics, and/or other properties of the hardware component.

One system and method to integrate software and hardware components within a design tool is disclosed in U.S. Pat. No. 6,742,165 B2 (“the '165 patent”) issued to Lev et al. The '165 patent discloses a system and method for a user to design an integrated circuit within a graphical user interface. The '165 patent includes a database and a system design tool wherein the user may browse and select, simulate, and prototype hardware, software, and middleware of an integrated circuit. Finally, the '165 patent allows the virtual testing of the designed integrated circuit.

Although the system design tool above may functionally interconnect software components and hardware components within a design environment, the software and hardware components may not be organized according to reusable asset specifications. Additionally, the system design tool may not be configured to generate a software code configured to interact with a selected hardware component. Finally, the system design tool may be applicable only to simulated design of new hardware. That is, the system design tool may not be applicable to the control, operation, and/or monitoring of previously designed hardware components.

The disclosed system design tool is directed to overcoming one or more of the problems set forth above.

### SUMMARY OF THE INVENTION

In one aspect, the present disclosure is directed to a plurality of software assets and at least one hardware asset configured to be selectively functionally interconnected with at least one of the plurality of software assets. The plurality of software assets and the at least one hardware asset are organized in accordance with reusable asset specifications.

In another aspect, the present disclosure is directed to a design environment including an asset catalog having a plurality of first assets including at least one software asset and at least one hardware asset organized in accordance with reusable asset specifications. The design environment further includes at least one asset repository having a plurality of second assets, wherein the plurality of second assets is a subset of the plurality of first assets and includes at least one software asset and at least one hardware asset.

In yet another aspect, the present disclosure is directed to a method of formulating a software code by accessing a system design tool having an asset catalog and at least one asset repository. The method includes accessing a first plurality of assets within the catalog, the first plurality of assets including software and hardware assets. The method further includes establishing a second plurality of assets in the at least one repository from the catalog, the second plurality of assets including software and hardware assets. The method still further includes selecting a subset of assets from the second plurality of assets, the subset of assets including at least one software asset and at least one hardware asset, and functionally interconnecting the subset of the second plurality of assets with one another.

### BRIEF DESCRIPTION OF THE DRAWINGS

FIG. 1 is a schematic illustration of a exemplary disclosed design environment;

FIG. 2 is a schematic illustration of an exemplary asset of the system design tool of the design environment of FIG. 1; and

FIG. 3 is a flow chart of an exemplary method of formulating software code within the design tool of FIG. 2.

### DETAILED DESCRIPTION

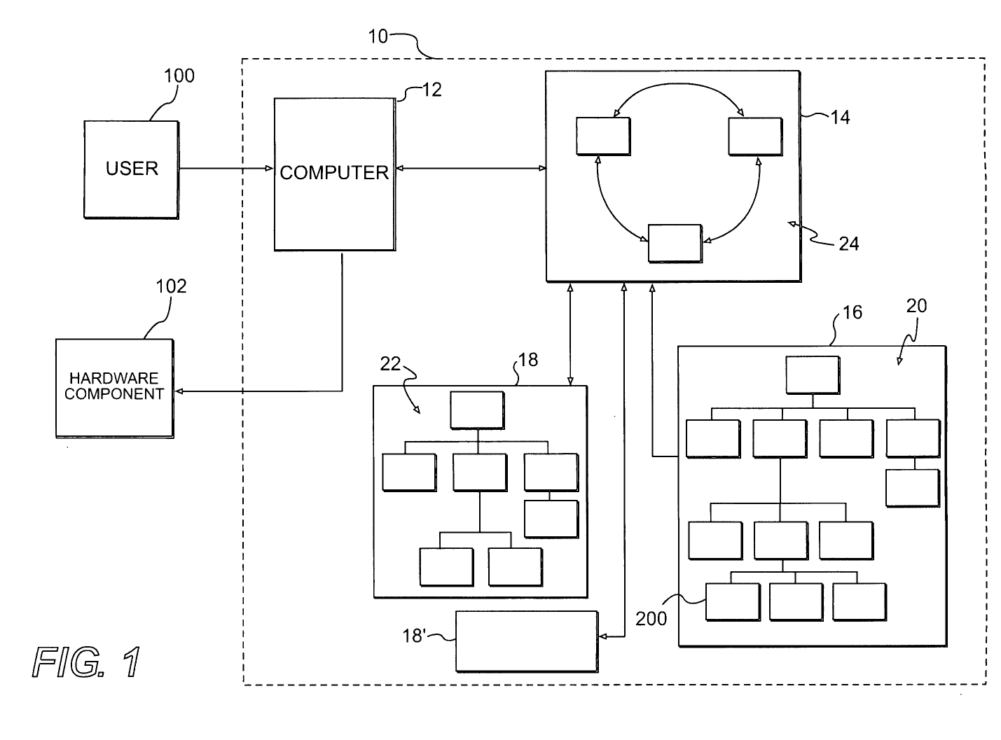

FIG. 1 illustrates an exemplary schematic of a design environment 10. Design environment 10 may include a computer 12, a system design tool 14, an asset catalog 16, and an asset repository 18. Computer 12 may be configured to accept user inputs from a user 100, communicate with system design tool 14, and output generated software code to interact with a hardware component 102.

System design tool 14 may be configured to receive user inputs from computer 12, functionally interconnect assets, generate software code, and output the generated software code to computer 12. Asset catalog 16 and asset repository 18 may be configured to be accessible by system design tool 14 to functionally select and transfer assets therebetween. It is contemplated that the software code may include any code necessary to operate, manipulate, control, monitor, and/or perform any other interaction with hardware component 102. It is also contemplated that hardware component 102 may include, for example, a sensor, a hydraulic valve, an engine, a work implement, and/or any other hardware element. It is further contemplated that hardware component 102 may include a plurality of hardware components (not shown).

Computer 12 may include a general purpose computer configured to operate executable computer code. Computer 12 may include one or more input devices, such as, for example, a keyboard (not shown) or a mouse (not shown) to introduce user inputs into computer 12; one or more data manipulation devices, such as, for example, databases (not shown) or software programs (not shown) to transfer and/or alter user inputs; and one or more communication devices, such as, for example, a modem (not shown) or a network link (not shown) to communicate inputs and/or outputs with system design tool 14. It is contemplated that computer 12 may further include additional and/or different components, such as, for example, a memory (not shown), a communications hub (not shown), a data storage (not shown), a printer (not shown), an audio-video device (not shown), removable data storage devices (not shown), or other components known in the art. It is also contemplated that computer 12 may communicate with system design tool 14 via, for example, a local area network (“LAN”), a hardwired connection, and/or the Internet. It is further contemplated that computer 12 may include a plurality of computers, each configured to communicate with system design tool 14.

System design tool 14 may be configured to communicate with computer 12, asset catalog 16, and asset repository 18 to functionally transfer and/or interconnect assets within a graphical user interface (“GUI”) (not shown). Specifically, system design tool 14 may be configured to add a second plurality of assets 22 to asset repository 18 from a first plurality of assets 20 in asset catalog 16 and to select a subset of assets 24 from asset repository 18 and functionally interconnect subset of assets 24. System design tool 14 may further be configured to generate software code at least partially based on the functionally interconnected subset of assets 24 and output the software code to computer 12. It is contemplated that system design tool 14 may be configured as a click and drag interface, where inputs from user 100 select icons within the GUI and selectively move the icons to interconnect assets; a read-write interface, where inputs from user 100 write commands within the GUI to interconnect assets; a drop down table interface, where inputs from user 100 select assets from organized tables within the GUI to functionally interconnect assets; or other graphical interfaces known in the art. It is contemplated that the generated software code may be a computer readable code and may be written in a known software format, such as, for example, a software flash file. It is further contemplated that the illustration of system design tool 14 interconnecting subset of assets 24 is for clarification purposes only and system design tool 14 may, within system limits, functionally interconnect any number of assets. It is further contemplated that system design tool 14 may be stored within the memory of computer 12 and/or within the memory of each of a plurality of computers 12 and may be configured to communicate with asset catalog 16 and asset repository 18 over the Internet.

Asset catalog 16 may include first plurality of assets 20 and may be configured to store and/or link to first plurality of assets 20 and interact with system design tool 14. Asset catalog 16 may embody a database or other data manipulation table known in the art. Asset catalog 16 may store and/or organize first plurality of assets 20 in accordance with reusable asset specifications (“RAS”). First plurality of assets 20 may include one or a plurality of software assets and/or one or a plurality of hardware assets. It is contemplated that first plurality of assets 20 stored and/or linked within asset catalog 16 may include, within practical limits, any number of assets. It is also contemplated that asset catalog 16 may directly be accessible by computer 12 via the Internet, such as, for example, without computer 12 communicating with system design tool 14.

Asset repository 18 may include second plurality of assets 22 and may be configured to store second plurality of assets 22 and interact with system design tool 14. Asset repository 18 may embody a database or other data manipulation table known in the art. Second plurality of assets 22 may form a subset of first plurality of assets 20. Asset repository 18 may store and/or organize second plurality of assets 22 in accordance with RAS. Second plurality of assets 22 may include one or a plurality of software assets and/or one or a plurality of hardware assets. It is contemplated that second plurality of assets 22 stored within asset repository 18 may include, within practical limits, any number of assets. It is also contemplated that asset repository 18 may include a plurality of asset repositories 18′ each configured to store a plurality of assets. It is also contemplated that asset repository 18 may be stored within the memory of computer 12, within a memory of a computer server (not shown), and/or may be accessible by system design tool 14 via the Internet. It is further contemplated that asset repository 18 may embody a single asset repository and may be configured to be accessible by a plurality of computers 12 and/or a plurality of system design tools 14.

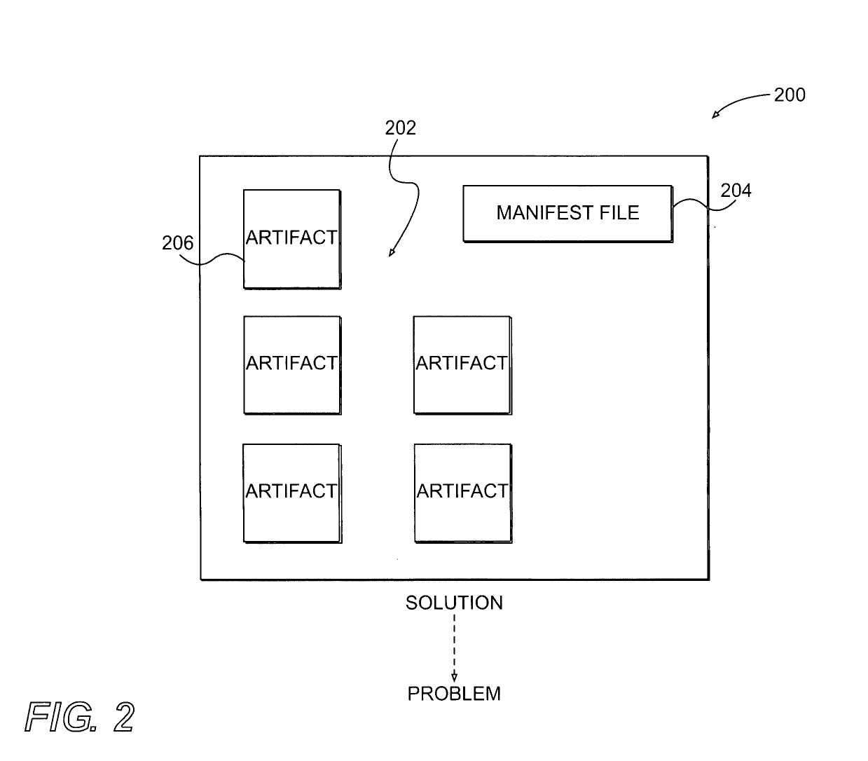

FIG. 2. illustrates an exemplary asset 200 to which reference is now made for clarification purposes only. It is understood that the description of asset 200 may be applicable to first plurality of assets 20, second plurality of assets 22, and/or subset of assets 24. Asset 200 may be configured to provide a solution to a problem for a given context and may include artifacts 202 and at least one manifest file 204. Artifacts 202 may include one or a plurality of artifacts. Additionally, asset 200 may include a variability point (not shown), rules for usage (not shown), and/or instructions (not shown) describing how the asset should be used. Specifically, artifacts 202 may be workproducts from a software development lifecycle, such as, for example, software code files, scripts, requirements, documents, and/or other workproducts known in the art. It is contemplated that artifacts 202 may also include an identifier to direct user 100 and/or system design tool 14 to a workproduct stored remotely from design environment 10. It is also contemplated that artifacts 202 may be stored in data fields within asset 200 and may include descriptors, such as, for example, name, function, benefit, requirements, content owner, use, compatibility, performance, brief description, and/or other descriptors known in the art and used to describe asset 200. It is also contemplated that the workproducts may include any known file format, such as, for example, .java, .doc, .xls, .gif, .txt, and/or other known file formats. It is further contemplated that asset 200 may include and/or embody a software code sub-routine and/or a hardware component configured to be interconnected with other assets that may embody software code sub-routines and/or hardware components to form a software code designed to interact with hardware component 102.

Asset 200 may specify required artifacts 202 and declare specific use contexts for asset 200. Assets, in general, may be described using at least three dimensions: granularity, variability, and articulation. Granularity may describe how many particular problems and/or solutions a particular asset addresses. For example, simple assets may offer a single solution or address a single well defined problem. As granularity increases, an asset may address multiple problems. Variability may describe the degree to which a user may alter the asset. For example, invariable assets may be fixed and unalterable. As variability increases, a user may be able to edit and alter an asset to meet specific user demands. Articulation may describe the degree of completeness of the artifacts 202 in providing a solution. For example, non-complex artifacts 202 may specify a solution, but may not provide the solution. As articulation increases, artifacts 202 may specify and implement a solution in connection with other supporting workproducts.

Asset 200 may include a software component. Asset 200 may be configured as a sub-routine to provide a software solution to a software problem. Specifically, asset 200 may include artifacts 202 configured to perform a sub-routine of a computer executable routine. Asset 200 may be configured to be interconnected with other software and/or hardware assets and may be configured to accept inputs, perform an algorithm, and deliver outputs. For example, asset 200 may accept inputs from another software and/or hardware asset, perform an algorithm with the accepted inputs to manipulate, change, and/or modify the accepted inputs, and deliver outputs to yet another software and/or a hardware asset. Artifacts 202 may include a description of the problem the sub-routine solves, the sub-routine, the required inputs, the delivered outputs, and/or other workproducts.

Alternatively, asset 200 may include a hardware component. Asset 200 may be configured as a virtual hardware component configured to provide a work output, such as, for example, an actuation, a visual display, a noise, and/or other work outputs. Asset 200 may be interconnected with other software and/or hardware assets and may be configured to accept inputs, perform work, and/or deliver outputs. For example, asset 200 may accept inputs from another software and/or hardware asset, perform predetermined work based in part on the accepted inputs, and deliver outputs to yet another software and/or hardware asset. Artifacts 202 may include a description of the problem the performed work solves, work itself, the required inputs, the delivered outputs, and/or other workproducts.

Manifest file 204 may reference artifacts 202 and may be configured as an eXtensible Markup Language (“XML”) document. Manifest file 204 may be configured to associate artifacts 202 with one another and/or asset 200 with other assets. It is contemplated that asset 200, including one or all of artifacts 202 and/or manifest file 204, may be packaged into a single archive file, such as, for example, using a Zip compression algorithm. Such a packaging may make distribution of asset 200 easier because of decreased file size and/or pre-management of the complexity of the asset.

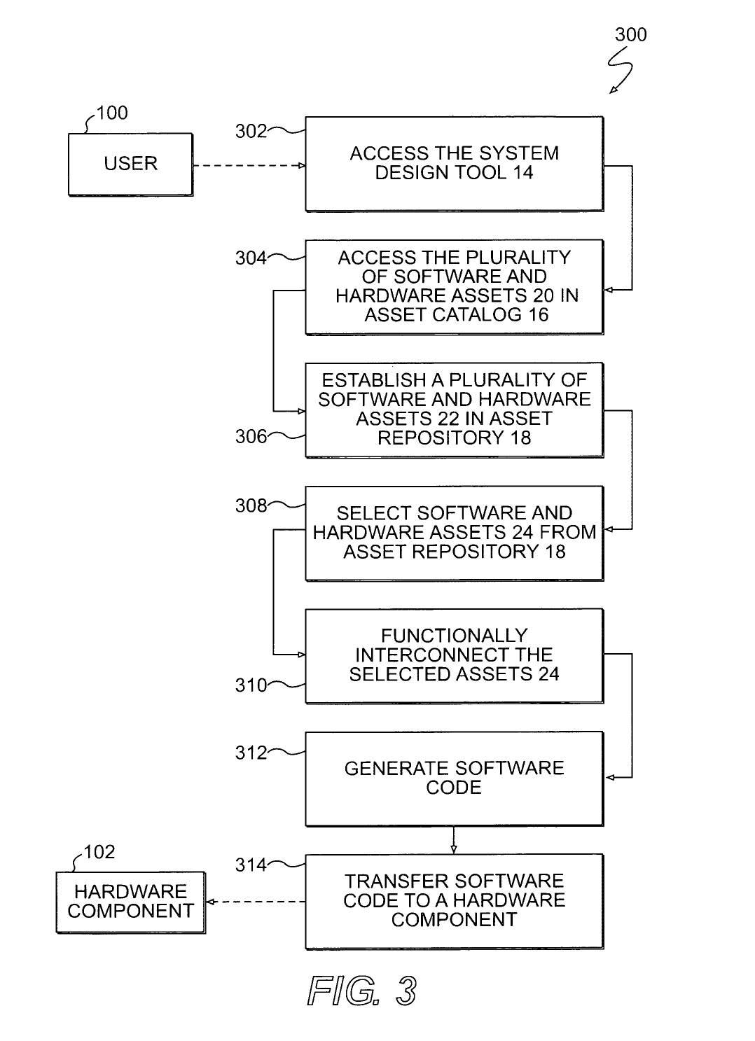

FIG. 3 illustrates an exemplary method 300 of formulating the software code generated by system design tool 14. Method 300 may be configured to enable user 100 to access software and hardware assets within design environment 10, to functionally interconnect assets within system design tool 14, and output the generated software to a hardware component 102. For example, user 100 may access system design tool 14 via computer 12 via a known logon or other known computer access protocol (step 302). User 100 and may access software and/or hardware assets of first plurality of assets 20 within asset catalog 16 to select assets therefrom (step 304). User 100 may establish second plurality of assets 22, including software and/or hardware assets, within asset repository 18 by transferring assets selected from asset catalog 16 to asset repository 18 (step 306). User 100 may establish subset of assets 24 within system design tool 14 by selecting software and/or hardware assets from second plurality of assets 22 (step 308). User 100 may input commands to system design tool 14 to functionally interconnect subset of assets 24 (step 310). System design tool 14 may generate software code at least partially based on the interconnected subset of assets 24 (step 312), and transfer the generated software code to hardware component 102 via computer 12 (step 314). It is contemplated that user 100 may also establish subset of assets 24 within system design tool 14 by selecting software and/or hardware assets from first plurality of assets 20 additionally and/or alternatively to selecting assets from second plurality of assets 22 during step 308.

### INDUSTRIAL APPLICABILITY

The disclosed system design tool 14 may be applicable to any design environment. The disclosed system design tool 14 may organize software and hardware components according to RAS, may generate software code to interact with a hardware component 102, and may provide a system design tool 14 configured to functionally interconnect software and hardware components within a GUT. The operation of design environment 10 and, more particularly, system design tool 14 is explained below.

Design environment 10 may be configured to generate a software code to control a hardware component 102. The generated software code may include an embedded code that is transferred from computer 12 to hardware component 102 and may be configured to operate, monitor, and/or manipulate hardware component 102. For example, the generated software code may embody a subroutine to monitor outputs from a temperature sensor and output a true-false value to a light emitting diode (“LED”) indicator. It is contemplated that the generated software code may include a code to operate, control, and/or interact with other software codes. It is further contemplated that the generated software code may be transferred to hardware component 102 via flash transfer protocol as is known in the art.

The following operation of system design tool 14 is illustrated with reference to a particular example of interconnecting assets. It is noted that the explanation below is for clarification purposes only, and the method and apparatus may be applicable for any interconnection of assets within a system design tool.

Assets 20 may be uploaded to asset catalog 16 in a manner known in the art. Assets 20 may be uploaded by a system administrator upon initialization of asset catalog 16 and/or periodically. The assets may be organized within asset catalog 16 based on any known organization, such as, for example, a table or a database listing.

System design tool 14 may access assets 20 in asset catalog 16 and/or assets 22 in asset repository 18 in response to user inputs communicated from computer 12 to establish subset of assets 24. System design tool 14 may display subset of assets 24 in the GUI, user 100 may select one or more of subset of assets 24, and user 100 may direct system design tool 14 to functionally interconnect the selected assets of subset of assets 24.

For example, user 100 may access system design tool 14 via computer 12 in order to generate a software code to operate a warning LED based on a temperature sensor. User 100 may view, via the GUI of system design tool 14, a list or table of available LEDs. Specifically, user 100 may browse through assets 20 and/or assets 22 to select a desired LED hardware asset and transfer the selected hardware asset into subset of assets 24. For example, user 100 may browse through assets 22 to find and select a red colored LED hardware asset. It is contemplated that user 100 may establish, in subset of assets 24, a plurality of duplicate assets. For example, user 100 may establish a multiple red colored LED hardware assets within subset of assets 24 by transferring duplicates of such an asset from asset repository 18 to system design tool 14.

User 100 may use a similar selection process to select other software and/or hardware assets 20, 22, such as, a temperature sensor asset, a control sub-routine asset, and/or other assets desired and/or necessary to operate the LED. It is contemplated that system design tool 14 may display within the GUI other necessary and/or potentially desirable assets from within assets 22 and/or assets 20. For example, if user 100 selects a LED hardware asset, system design tool may be configured to automatically display a plurality of power assets and/or a plurality of other assets compatible with, necessary for, and/or desirable to be interconnected with an LED asset.

Assuming asset 200 is a red colored LED hardware asset, artifacts 202 may include physical properties and specifications regarding asset 200. Specifically, artifacts 202 may include physical characteristics, such as, for example, volume, dimensions and/or other physical characteristics, power needs, required inputs, and/or other workproducts associated with asset 200.

Because hardware assets may be included within first plurality of assets 20, second plurality of assets 22, and/or subset of assets 24, software assets that may be configured to interact with hardware components 102 can be interconnected within system design tool 14. Hardware component 102 required inputs, outputs, and other operation requirements can be stored within a hardware asset and, in particular, can be stored within artifacts 202 of a hardware asset enabling system design tool 14 to generate a computer executable code configured to properly interact with a hardware component 102 without requiring special knowledge of a user regarding the requirements of such a hardware component 102.

Additionally, because hardware assets may be organized according to RAS, hardware assets may be more easily organized, searched, and/or selected by user 100. System design tool 14 may be configured to more easily interconnect software assets and hardware assets within a virtual space and enable user 100 to recognize and accordingly select appropriate software assets for specified hardware assets, including, for example, required hardware component inputs, outputs, compatibility, and other hardware specifications. Furthermore, system design tool 14 may enable user 100 to generate software code for previously designed hardware components 102.

It will be apparent to those skilled in the art that various modifications and variations can be made to the disclosed system design tool 14 and in particular to the disclosed hardware assets organized according to RAS. Other embodiments will be apparent to those skilled in the art from consideration of the specification and practice of the disclosed system design tool. It is intended that the specification and examples be considered as exemplary only, with a true scope being indicated by the following claims and their equivalents.

What is claimed is:

1. An asset catalog, comprising:
a plurality of software assets; and
at least one hardware asset configured to be selectively functionally interconnected with at least one of the plurality of software assets;
wherein the plurality of software assets and the at least one hardware asset are organized in accordance with reusable asset specifications.

2. The asset catalog of claim 1, wherein the reusable asset specifications for the plurality of software assets and the at least one hardware asset include a least one of performance data, compatibility data, and function data.

3. The asset catalog of claim 2, wherein the reusable asset specification for the at least one hardware asset includes physical property data.

4. The asset catalog of claim 2, wherein each of the plurality of software assets and each of the at least one hardware asset include a plurality of artifacts configured as workproducts.

5. The asset catalog of claim 1, wherein the at least one hardware asset is a plurality of hardware assets and each of the plurality of hardware assets is configured to be selectively functionally interconnected with at least one of the plurality of software assets.

6. The asset catalog of claim 1, wherein the plurality of software assets and the at least one hardware asset are configured to be removable to at least one asset repository.

7. The asset catalog of claim 1, wherein the asset catalog is configured to be accessible by a system design tool.

8. A design environment, comprising:
an asset catalog having a plurality of first assets including at least one software asset and at least one hardware asset organized in accordance with reusable asset specifications; and
at least one asset repository having a plurality of second assets;
wherein the plurality of second assets is a subset of the plurality of first assets and includes at least one software asset and at least one hardware asset.

9. The design environment of claim 8, wherein a system design tool is configured to functionally interconnect at least one software asset from the plurality of second assets with at least one hardware asset from the plurality of second assets.

10. The design environment of claim 8, wherein the reusable asset specifications of the plurality of first assets include at least one of performance data, compatibility data, and function data.

11. The design environment of claim 10, wherein the reusable asset specification of the at least one hardware asset includes physical property data.

12. The design environment of claim 8, wherein the at least one asset repository includes a plurality of asset repositories each having a plurality of second assets.

13. The design environment of claim 8, wherein the plurality of second assets are organized in accordance with reusable asset specifications.

14. The design environment of claim 13, wherein the reusable asset specifications of the plurality of second assets include at least one of performance data, compatibility data, and function data.

15. A method of formulating a software code, comprising:
accessing a system design tool having an asset catalog and at least one asset repository;
accessing a first plurality of assets within the catalog, the first plurality of assets including software and hardware assets;
establishing a second plurality of assets in the at least one repository from the catalog, the second plurality of assets including software and hardware assets;
selecting a subset of assets from the second plurality of assets, the subset of assets including at least one software asset and at least one hardware asset; and
functionally interconnecting the subset of the second plurality of assets with one another.

16. The method of claim 15, wherein selecting a subset of second assets includes:
selecting a first asset;
displaying a third plurality of assets each configured to be compatible with the first asset.

17. The method of claim 16, further including selecting a second asset from the third plurality of assets.

18. The method of claim 17, further including functionally interconnecting the first asset and the second asset.

19. The method of claim 18, wherein the first asset is a software asset and the second asset is a hardware asset.

20. The method of claim 15, further including:
creating a software code to control the subset of assets; and
transferring the software code to a hardware component.
